(19) United States
(12) Patent Application Publication
(10) Pub. No.: US 2019/0124106 A1
(43) Pub. Date: Apr. 25, 2019

(54) EFFICIENT SECURITY THREAT REMEDIATION

(71) Applicant: T-Mobile USA, Inc., Bellevue, WA (US)

(72) Inventor: Ismael Navarro, Redmond, WA (US)

(21) Appl. No.: 15/788,755

(22) Filed: Oct. 19, 2017

(51) Int. Cl. H04L 29/06

(52) U.S. Cl. CPC H04L 63/1433; H04L 63/1425

(57) ABSTRACT

Techniques for efficient remediation of enterprise security threats are disclosed that use historical remediation implementations and security vulnerability report cross-references to reduce the resources required to remediate reported vulnerabilities in enterprise software deployments. Multiple security tools are used to identify existence of vulnerabilities and provide a confidence level for a recommended remediation. When there is high confidence that a proposed remediation is correct for an enterprise, the remediation is implemented without further design or development of the remediation. Cross-references among multiple reports are used to reduce redundancies in the threat remediation process.

### BACKGROUND

Enterprises are prime targets for cybersecurity threat actors. Accordingly, enterprises make use of third-party security tools to scan computing infrastructure for known threats. When such security tools are discovered, they are typically reported to the National Institutes of Standards and Technology (NIST) who, in turn, categorizes and taxonomizes the threats and associates a threat identifier—called a Common Vulnerability and Exposure (CVE). Security companies develop tools to detect CVE threats and also propose recommendations to eliminate or otherwise remediate the threats. However, enterprises vary widely, and proposed remediations are often not compatible with a particular enterprise computing system. Some remediations may be incompatible with previous remediations, some remediations may be too narrow, etc. Additionally, recommended remediations for the same vulnerability may differ between security tools. Accordingly, an enterprise is obliged to expend resources to customize its own remediation strategy.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a diagram of an example enterprise computing system environment in which the technological solutions described herein may be implemented.

FIG. 2 is a diagram of an example computing device in accordance with the technologies described herein.

FIG. 3A is a first part of a flow diagram of an example methodological implementation for efficiently remediating security threats.

FIG. 3B is a first part of a flow diagram of an example methodological implementation for efficiently remediating security threats.

### DETAILED DESCRIPTION

### Overview

Enterprise information technology systems are typically made up of many different electronic devices, software systems and components. Software systems may be created by the enterprise, but are often obtained from software vendors, large and small. Software vendors continuously test their products to detect bugs and possible security vulnerabilities. From time to time, a software vendor will provide a software update to remediate problems, or bugs, detected in the software vendor's product. Sometimes, the updates relate to execution problems with the software. However, the updates may also relate to security vulnerabilities in the code that can be exploited by malicious actors to access secured data, cause the software to do something it was never intended to do, etc.

When security issues are detected, they are typically reported to NIST, which acts as an aggregator for security issues in computer systems. NIST associates a CVE (Common Vulnerabilities and Exposure) identifier to each issue and provides a standardized threat report to entities that may use affected software. Each CVE includes a CVE identifier number (e.g., “CVE-2014-100001”), a description of the vulnerability, and pertinent references.

Information security tools, also called “scanners,” are available that provide security solutions to manage software vulnerabilities, so as to detect and protect against malicious attacks. Examples of some such security tools are Metasploit® by Rapid7, LLC®, OpenVAS by Greenbone® Networks, Qualsys®, etc. Such security tools develop techniques to detect CVE threats and propose recommendations to eliminate or otherwise remediate the threat. However, vendor-supplied enterprise software does not exist in isolation in an enterprise environment. While software and security tool vendors are able to test standalone software packages, the software package implemented in the enterprise environment interfaces with many different variations of vendor-supplied and custom software. As a result, remediations recommended by a security tool may not work when implemented in an enterprise environment. When that happens, custom remediations may be designed, developed, and tested, or an update recommendation may not be performed.

In either case, something other than the recommended remediation was implemented. For example, updating a new driver may produce an adverse result. In response, a decision may be made to continue to use the old driver, or some small changes need to be made in the system to make the driver work. The ultimate remediation, or lack of remediation, is institutional knowledge that is often lost. In some of the implementations described below, this information is retained in a history that is used to inform future remediation implementations so as to reduce future resources applied to updates.

In one or more described implementations, multiple security tools are used to scan for existence of vulnerabilities and to propose remediations in unique threat reports. Using the multiple reports, a confidence level for a recommended remediation is assigned. When there is high confidence that a proposed remediation is correct for an enterprise, the remediation is implemented without further design or development of the remediation. For example, if two or more reports cite the same vulnerability and recommend the same remediation, then a high confidence level may be assigned to the proposed remediation. Otherwise, a lower confidence level may be assigned to the proposed remediation, in which case further analysis may be undertaken prior to implementing the same or a different remediation.

An inefficiency can arise when different threat detection reports identify the same vulnerability, but use different identifiers for the vulnerability (i.e. not the standardized CVE). In at least one implementation described herein, a security vulnerability report cross-reference is used to identify similar threats in different vulnerability reports, which can be used to reduce redundancies in the threat remediation process.

### Example Network Environment

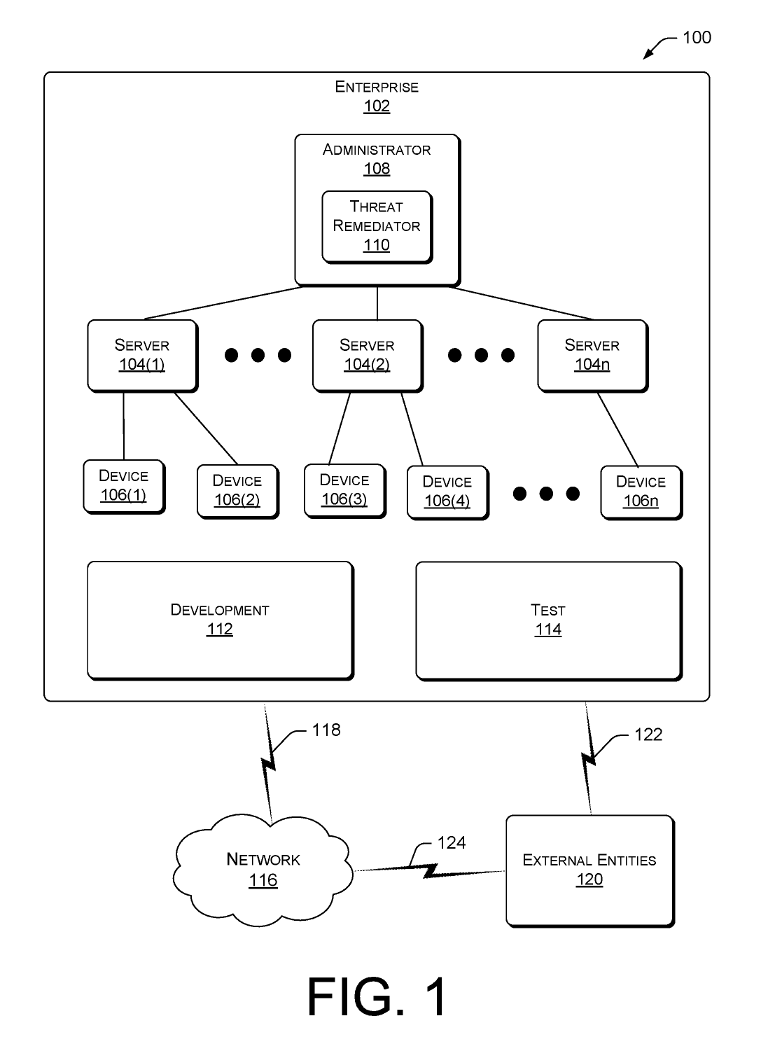

FIG. 1 is a diagram of an example enterprise computing system environment in which the technological solutions described herein may be implemented. It is noted that, although the present discussion refers to an enterprise network, the techniques described herein may be applied to smaller systems or networks.

The enterprise computing system environment 100 includes an enterprise 102 having multiple electronic devices 104(1)-104(n) served by multiple servers 106(1)-106(n), as is typical in an enterprise environment. The multiple electronic devices 104(1)-104(n) can be any type and combination of electronic devices, such as personal computers, laptop computers, tablet computers, cellular telephones, printers, copiers, etc., that are at least to some extent monitored and controlled by an entity within the enterprise 102.

An administrator 108 is also present in the enterprise 102, which is a computing device that is used to manage content and functionality of the multiple electronic devices 104(1)-104(n) and the multiple servers 106(1)-106(n), and controls software management and updates in the electronic devices 104(1)-104(n). In the present discussion, “administrator” can refer to a computing device that manages enterprise resources, or to a person who operates a computing device to manage enterprise resources.

The administrator 108 hosts a threat remediator 110, which is an application that performs the operations and techniques described herein. As discussed in greater detail, below, the threat remediator 110 is used to identify software vulnerabilities in enterprise software and manage remediations designed to neutralize any threats.

The enterprise 102 also includes a development center 112 and a test center 114. The development center 112 and the test center 114 provide software development and testing services, respectively. In a typical enterprise, the development center 112 and the test center 114 are usually departments made up of several employees each, but smaller enterprises may have reduced staffing or some services may be automated.

The enterprise computing system environment 100 also includes a network 116, such as the Internet, with which the servers 102(1)-102(n) and electronic devices 104(1)-104(n) may communicate via a wired or wireless link 118. The enterprise 102 also communicates with several external entities 120, such as authentication entities, business entities, storage entities, or any type of individual or enterprise computing system. the enterprise 102 communicates with the external entities directly via link 122, or indirectly via a link 124 to the network 116.

Further details of the enterprise computing system environment 100 are described below, with reference to subsequent figures.

### Example Computing Device

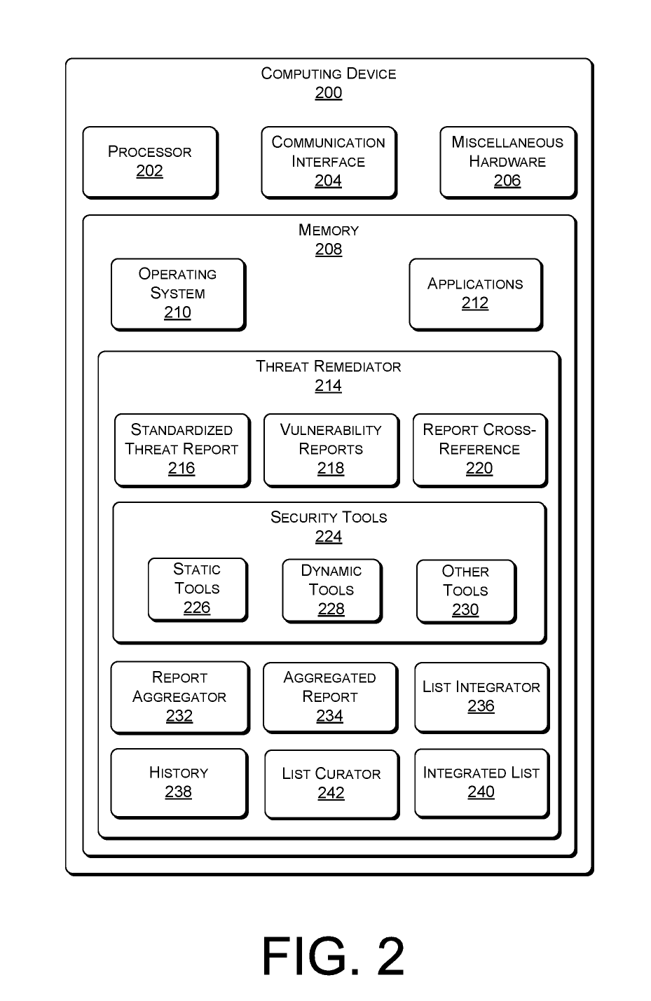

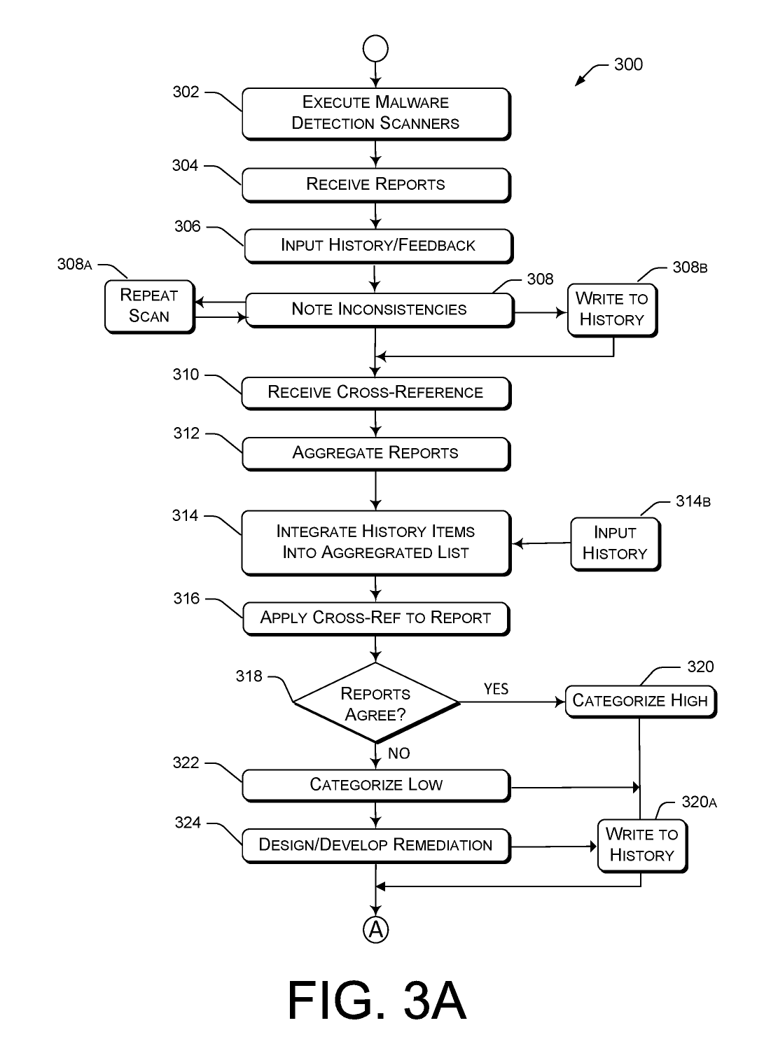

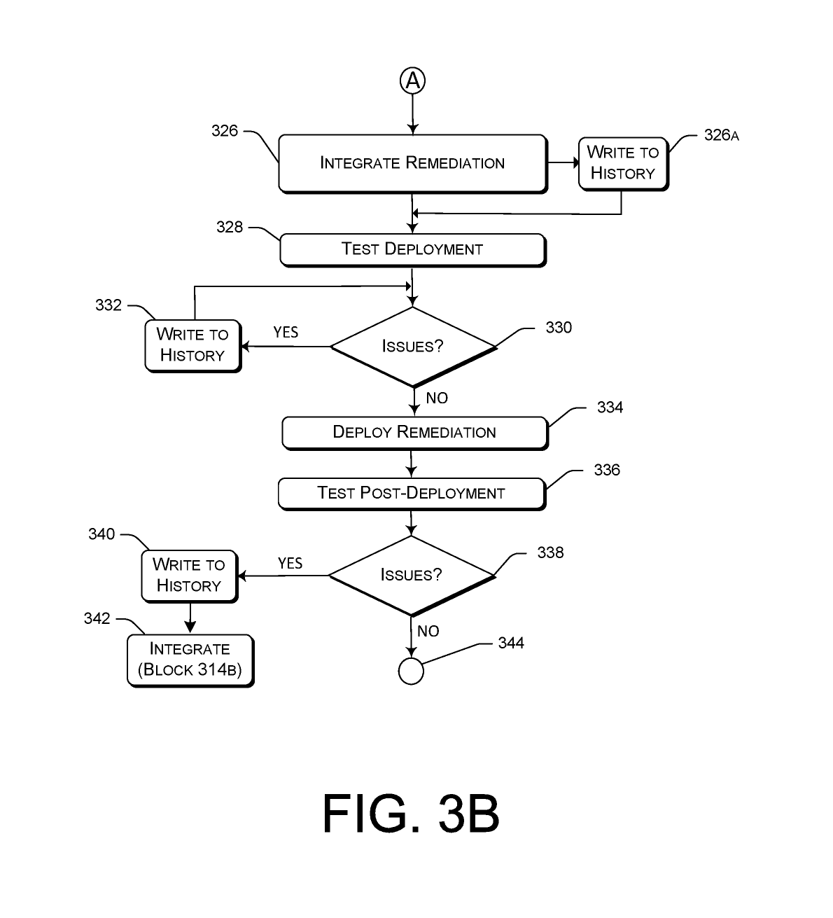

FIG. 2 is a diagram of an example computing device 200 in accordance with the technologies described herein. In the following discussion of FIG. 2, continuing reference may be made to components and reference numerals shown and described in FIG. 1. It is noted that the components shown and described in FIG. 2 may be implemented in software, hardware, firmware, or a combination thereof. Details of functionality of the example computing device 200 and its components are discussed briefly immediately below, and in greater detail with respect to the discussion related to FIG. 3, below.

The example computing device 200 includes a processor 202 that includes electronic circuitry that executes instruction code segments by performing basic arithmetic, logical, control, memory, and input/output (I/O) operations specified by the instruction code. The processor 202 can be a product that is commercially available through companies such as Intel® or AMD®, or it can be one that is customized to work with and control and particular system.

The example computing device 200 also includes a communications interface 204 and miscellaneous hardware 206. The communication interface 204 facilitates communication with components located outside the example computing device 200, and provides networking capabilities for the example computing device 200. For example, the example computing device 200, by way of the communications interface 204, may exchange data with other electronic devices (e.g., laptops, computers, other servers, etc.) via one or more networks, such as the network 116 (FIG. 1) and external entities 120 (FIG. 1). Communications between the example computing device 200 and other electronic devices may utilize any sort of communication protocol known in the art for sending and receiving data and/or voice communications.

The miscellaneous hardware 206 includes hardware components and associated software and/or or firmware used to carry out device operations. Included in the miscellaneous hardware 206 are one or more user interface hardware components not shown individually—such as a keyboard, a mouse, a display, a microphone, a camera, and/or the like—that support user interaction with the example computing device 200.

The example computing device 200 also includes memory 208 that stores data, executable instructions, modules, components, data structures, etc. The memory 208 is be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 210 is stored in the memory 208 of the example computing device 200. The operating system 200 controls functionality of the processor 202, the communications interface 204, and the miscellaneous hardware 206. Furthermore, the operating system 210 includes components that enable the example computing device 200 to receive and transmit data via various inputs (e.g., user controls, network interfaces, and/or memory devices), as well as process data using the processor 202 to generate output. The operating system 210 can include a presentation component that controls presentation of output (e.g., display the data on an electronic display, store the data in memory, transmit the data to another electronic device, etc.). Additionally, the operating system 210 can include other components that perform various additional functions generally associated with a typical operating system. The memory 210 also stores various software applications 212, or programs, that provide or support functionality for the example computing device 200, or provide a general or specialized device user function that may or may not be related to the example computing device per se. For example, the software applications 212 may provide or support functionality for other servers (FIG. 1, 104) or other electronic devices (FIG. 1, 106).

The memory 208 also stores a threat remediator 214 that is similar to the threat remediator 110 at the administrator 108 in FIG. 1. The threat remediator 214 performs and/or controls operations to carry out the techniques presented herein. The threat remediator 124 includes several components that are described immediately below, and further below with respect to the functional flow diagram shown in FIG. 3.

In the following discussion, certain functions and interactions may be attributed to particular components. It is noted that in at least one alternative implementation not particularly described herein, other component functions and interactions may be provided. Furthermore, components shown as residing within the threat remediator 214 may actually reside outside the threat remediator 214 and communicate with the threat remediator 214. Also, one or more components may not be permanent and may only reside in the threat communicator (or in communication with the threat remediator but resident external thereto) at particular times. For example, some reports may not always be present, but only after the reports are generated or received. Furthermore, an item designated as a component may be dynamic rather than static, in that the component sometimes contains different information.

The following discussion of FIG. 2 merely represents a subset of all possible implementations. Furthermore, although other implementations may differ, the threat remediator 214 is described as a software application that includes, and has components that include, code segments of processor-executable instructions. As such, certain properties attributed to a particular component in the present description, may be performed by one or more other components in an alternate implementation. An alternate attribution of properties, or functions, within the threat remediator 214, and even the example computing device 200 as a whole, is not intended to limit the scope of the techniques described herein or the claims appended hereto.

The threat remediator 214 includes a standardized threat report 216 that is received from an external source, such as NIST. The standardized threat report 216 includes vulnerability items, such as CVEs, that each identify a vendor-supplied software application vulnerability that has been detected. In at least one alternate implementation, the standardized threat report 216 is not necessarily stored in the memory 208, but may be accessed directly or indirectly from a provider (not shown) of the standardized threat report 216.

The threat remediator 214 also includes vulnerability reports 218 that are generated by external entities 120 (FIG. 1) and received by the computing device 200, or are generated within the computing device 200 as described below. The vulnerability reports 218 include items that each identify a vulnerability detected in specified software and a proposed remediation for the identified vulnerability that, when implemented, is purported to eliminate the identified vulnerability.

A report cross-reference 220 is utilized in one or more implementations described herein. The report cross-reference 220 is information that correlates vulnerabilities among multiple vulnerability reports 218. For example, even though they relate to the same vulnerability, a first vulnerability report may indicate a vulnerability as reference number “2017-06-001010,” and a second vulnerability report may indicate a vulnerability as reference number “2017-001001-06-A.”

The report cross-reference 220 indicates that the reference numbers relate to the same vulnerability. As such, proposed remedies associated with the vulnerability can be compared directly to determine if there is a variance. In implementations that do not use the report cross-reference 220, a comparison operation may be required to determine if different vulnerability reports 218 refer to similar vulnerabilities. Use of the report cross-reference 220 conserves resources and is, therefore, more efficient.

The threat remediator 214 also includes multiple security tools 224, or “scanners.” The security tools 224 are used to scan code to detect vulnerabilities and provide the vulnerability reports 218. One or more of the security tools 224 can be a static tool 226, which scans static code for vulnerabilities. At least one of the security tools 224 can be a dynamic tool 228, which scans for vulnerabilities in executing code. Yet one or more other tools 230 can be other types of vulnerability scanners that scan other things in an attempt to identify vulnerabilities. Other tools 230 can be a register scan that scans for issues in registers, file server scanners to detect for issues (such as ransomware) in file server activities, etc.

The threat remediator 214 includes a report aggregator 232 that aggregates the multiple vulnerability reports 218 into a single aggregated report 234. The threat remediator 214 also includes a list integrator 236 that collects entries from a history 238 and integrates them into the aggregated report 234 to create an integrated list 240. Details of the history 238 and the integration process are described in greater detail below, with respect to FIG. 3.

A list curator 242 is also included in the threat remediator 214 of the example computing device 200. The list curator 242 provides an efficiency in the development process to integrate vulnerability remedies, in that it determines if there are any proposed remediations for verified vulnerabilities that can be implemented without initial testing and/or design and/or development. In at least one implementation, the list curator 242 assigns a confidence level to a proposed remediation. Remediations assigned a high confidence level are handle differently that remediations assigned a lower confidence level. For example, if the list curator 242 determines that proposed remedies from more than one report relate to the same vulnerability are identical, it may assign a high confidence level to the proposed remedy. As such, it may be implemented immediately without additional analysis.

In this determination, the list curator 242 also verifies there is not information in the history 238 contradicts the proposed remedy, i.e., that indicates that the proposed remedy should not be implemented. For example, if the history 238 indicates that the proposed remedy has been previously implemented, but it caused unacceptable artifacts in the system, then a decision can be made to forego implementation of the proposed remedy or to analyze the vulnerability associated with the proposed remedy to determine if the proposed remedy can be implemented in a way so as not to cause the undesirable artifacts.

The history 238 may be implemented in any one of several ways. It may be a flag, associated with a CVE or other descriptor of a vulnerability, that is set to a value indicated whether there is an issue with a proposed remedy for the vulnerability. If the flag has a value that indicates no issue was found, then the history will not adversely affect the confidence level assigned to the proposed vulnerability. The history 238 may also be a textual description that can be read by an administrator or comprehended by a machine that informs an action to take with regard to a specific vulnerability and proposed remediation.

Other aspects and characteristics of the computing device 200, the threat remediator 214, and components thereof are discussed below, with respect to an example of an operational method utilizing the same.

### Example Methodological Implementation

FIG. 3 is a flow diagram 300 that depicts a methodological implementation of at least one aspect of the techniques for efficient security threat remediation disclosed herein. In the following discussion of FIG. 3, continuing reference is made to the elements and reference numerals shown in and described with respect to the example computing device 200 of FIG. 2. In the following discussion related to FIG. 3, certain operations may be ascribed to particular system elements shown in previous figures. However, alternative implementations may execute certain operations in conjunction with or wholly within a different element or component of the system(s).

At block 302, multiple security tools 224 (FIG. 2), i.e. vulnerability detection scanners, are executed. The security tools 224 may be executed against static code, against code during execution, against registers, component activities, etc. Each security tool 224 produces a vulnerability report 218 that is received at block 304. Each vulnerability report 218 lists at least a vulnerability reference number and a proposed remediation, which is a recommendation of specific steps to provide a fix to the vulnerability. Although not explicitly shown in FIG. 3, the security tools 224 may be executed in conjunction with an attempt to reproduce a vulnerability identified in a standardized threat report 216, e.g. CVE listings from NIST.

At block 306, the history 236 from previous vulnerability remediations is input and inconsistencies are identified at block 308. Inconsistencies exist when one vulnerability report proposed a different recommendation for a vulnerability than does a different vulnerability report. For example, if a first report identifies vulnerability “2016-22-100100” and recommends a remediation, and if a second report identifies vulnerability “2016-22-100100” but recommends a different remediation, then there is an inconsistency. Another example of an inconsistency is when a proposed recommendation—even if agreed upon by all the vulnerability reports 218—is contradicted by the history 236. For example, if the vulnerability reports indicate that “Driver 009” should be updated to “Driver 010,” but the history 236 indicates that previous implementations of “Driver 010” were installed but caused too many undesirable artifacts, resulting in continued use of “Driver 009,” then there is an inconsistency.

In some cases, one or more security tool scans are repeated at block 308A. One such case is when vulnerability reports do not agree on recommended solutions. Another case is when the vulnerability listed on the standardized vulnerability report 216 is not detected by a security tool scan. If the scan(s) is/are repeated and an inconsistency still exists, the process continues after the inconsistency(ies) is/are noted in the history 236 (block 308B).

At block 310, the report cross-reference 220 is received. This operation is carried out in one of various ways. In at least one implementation, the report cross-reference 220 is received from an external source, such as a vendor. In at least one other implementation, the threat remediator 214 creates the cross-reference from analyses of the multiple vulnerability reports. In still another implementation, block 306 is not performed, though utilizing the report cross-reference provides additional efficiencies. In such an implementation, each report would be analyzed and compared to others in an attempt to confirm that a vulnerability listed in a first report is the same as a vulnerability listed under a different reference number in a second report.

At block 312, the multiple vulnerability reports 218 are by the report aggregator 232. This produces the aggregated report 234 that contains all unique entries from each of the multiple vulnerability reports 218. Although not explicitly shown in the example methodological implementation 300, each of the multiple vulnerability reports 218 may be converted into a common data format prior to the aggregation to provide efficiency for this operation. Various ways are known to accomplish this, including using various vendor-supplied tools, such as Hortonworks®, or Apache® Hadoop®. Converting the aggregated report 234 into a common data format allows for faster handling and more robust operations.

At block 314, the aggregated report 234 is used to create the integrated list 240 by integrating the history 236 (block 314B). The history 236 includes feedback from historical attempts to implement vulnerability remediations. This allows institutional knowledge to be retained and automatically considered in future cycles to remediate vulnerabilities. As the implementation cycle continues, certain actions taken that are related to CVEs (i.e. vulnerabilities) are written to the history 236, and the history 236 is relied upon in making certain decisions.

At block 316, the report cross-reference 220 is applied to the integrated list 240 by the list integrator 236. The process of applying the report cross-reference 220 identifies unique entries that relate to the same vulnerability, and that can be consolidated. If vulnerability identifiers come from a non-standard source (i.e. not NIST), then different vulnerability identifiers can refer to the same vulnerability and a similar proposed remedy. Rather than treat each of these as different vulnerabilities, the different vulnerability identifiers are associated, such as by a pointer, so that when one vulnerability identifier is being considered, the proposed remediations for that particular identifier and one related to the same issue will be considered together. This provides an efficiency of not considering the same vulnerability multiple times, and provides a more accurate assessment of whether inconsistencies exist between proposed remedies.

At block 318, the list curator 242 categorizes the proposed remedies. Although any arbitrary classification system may be used in this regard, the following discussion focuses on classifying proposed remedies into two categories. A first category relates to proposed remediations that may be implemented without additional analysis, design, or development. The second category relates to proposed remediations that need further analysis before they are implemented. The categories may have any unique names, but for the present discussion, the categories will be referred to as “high” and “low” (to reflect proposed remedies determined to have a high confidence level that they can be implemented without causing undesirable artifacts, of a low confidence level otherwise). But more granular categories may also be implemented, such as dividing “low confidence” remedies further to account for how much effort and resources may need to be expended to determine a correct fix, or to have a unique category that indicates a severe problem that needs to be escalating, such as something that may indicate a malware attack.

At block 318, a determination is made as to whether different ones of the multiple vulnerability reports 218 are in agreement. A variable standard for what indicates that a remediation should be implemented without further analysis may be implemented. In at least one implementation, if all vulnerability reports recommend the same remediation for a vulnerability (“Yes” branch, block 318), then the recommend remediation is labeled “high” at block 320, and an entry is made to the history 238 at block 320A) to indicate that the implementation was made as recommended. The remediation is then integrated into the development process as recommended (block 326). In at least one other implementation, if most (or all but one, or a certain pre-specified number) agree on a remediation for a vulnerability, the remediation may be considered as having a “high” level of confidence.

In at least one other implementation, multiple confidence levels may be implemented, where a highest confidence level is assigned when all vulnerability reports agree on a recommended remediation, and a medium confidence level may be assigned when more than one of the vulnerability reports agree. Finally, a low confidence level may be assigned where each vulnerability report recommends a different remediation. Each category may then be handled differently. In the present example methodological implementation, however, remediations not having the highest level of confidence are treated similarly.

If no two reports recommend the same remediation for a vulnerability (“No” branch, block 318), then there is a “low” confidence that any one of the remediations should be implemented as recommended and an entry is made to the history 238 to memorialize details regarding the decision. The vulnerability issue is then directed appropriately to receive more attention for design and development (block 324). Entries regarding this finding and what was actually implemented for the remediation are written to the history 238 at block 320A. Thereafter, at block 326, the remediation is integrated into the development process.

Typically, potential remediations are developed and tested on a sub-set of an enterprise information system. After a remediation has been accepted for deployment, the remediation is deployed into the entire enterprise information system. At block 328, further testing is done on the deployed remediation. If issues are detected (“Yes” branch, block 330), then the issues are written in the history 238 (block 332) and further testing is done at block 328. When no further issues are detected (“No” branch, block 330), then the remediation is fully deployed at block 334.

At block 336, further testing is performed on the post-deployed remediation. This testing may be passive in that typical software problem reports are generated by enterprise members after the deployment. If problems are detected (“Yes” branch, block 338), then a description of the problem(s) is/are written to the history 238 at block 340, after which the issues are integrated into the integrated list 240 at block 314/314B. As long as no problems are detected (“No” branch, block 338), the process terminates or reverts to begin anew at block 344.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving multiple threat detection reports;
creating an aggregated report that includes vulnerabilities and associated proposed remedies from each of the multiple threat detection reports;
associating a history of each vulnerability in an integrated list;
comparing proposed remedies for similar vulnerabilities;
if proposed remedies for a vulnerability agree and there is not a contradiction in the history associated with the vulnerability, integrating the proposed remediation into a development process without further remediation design.

2. The method as recited in claim 1, further comprising receiving a cross-reference report that correlates vulnerabilities from the multiple reports.

3. The method as recited in claim 2, further comprising:
comparing the cross-reference report to the integrated list to identify redundant vulnerabilities in the integrated list; and
deleting redundant vulnerabilities from the integrated list.

4. The method as recited in claim 1, wherein the history further comprises feedback from previous remediations in the development process.

5. The method as recited in claim 1, wherein the receiving multiple threat detection reports further comprises:
receiving a security threat report; and
running multiple security threat detection tools to identify a presence of a vulnerability disclosed in the security threat report and to create the multiple threat detection reports.

6. The method as recited in claim 1, wherein a contradiction in the history associated with the vulnerability further comprises the history indicating that a remediation associated with a vulnerability has been previously implemented and found to be defective.

7. The method as recited in claim 1, wherein the creating an integrated list further comprises incorporating vulnerabilities received in feedback from the development process.

8. The method as recited in claim 1, wherein the creating an integrated list further comprises incorporating issues reported in deployment of previous vulnerability remediations.

9. A system, comprising:
a processor;
memory;
multiple vulnerability reports that indicate one or more threat vulnerabilities and a proposed remediation for each of the threat vulnerabilities;
a history that identifies previous vulnerabilities that were addressed and actions that were taken in regard thereto;
a report aggregator that produces an aggregated report that includes the vulnerabilities and proposed remediations from the multiple vulnerability reports;
a list integrator that integrates information included in the history related to each vulnerability; and
a list curator that determines if proposed remedies for a vulnerability that appears in two or more of the multiple vulnerability reports are the same and, if so, to categorize the vulnerability such that the proposed remedy is integrated into a development process without additional remediation analysis.

10. The system as recited in claim 9, further comprising a vulnerability report cross-reference that can be used to correlate vulnerabilities among reports and remove redundancies.

11. The system as recited in claim 9, further comprising multiple security tools that are executed to create the multiple vulnerability reports.

12. The system as recited in claim 11, wherein the multiple security tools are executed to identify vulnerabilities identified by an external entity.

13. The system as recited in claim 9, wherein the history further includes feedback related to issues detected in deployment of previous vulnerability remediations.

14. One or more computer-readable media that, when executed, perform the following operations:
receiving a standardized threat report that identifies potential security vulnerabilities in enterprise software, together with proposed fixes for the security vulnerabilities;
generating a vulnerability report from each of multiple security tools executed to detect enterprise vulnerabilities identified in the standardized report;
aggregating the vulnerability reports in a common data format to create an aggregate report that identifies at least a proposed fix for each vulnerability;
for each vulnerability, determining a confidence level for a corresponding proposed fix, the confidence level indicating whether additional analysis should be undertaken prior to implementing the proposed fix;
for vulnerabilities having a high confidence level, directing further action on the proposed fix so that additional analysis is not performed prior to implementing the proposed fix.

15. The one or more computer-readable media as recited in claim 14, further comprising additional computer-executable instructions that, when executed, perform the operation of receiving a cross-reference that correlates vulnerabilities in the vulnerability reports.

16. The one or more computer-readable media as recited in claim 14, wherein the determining a confidence level further comprises integrating historical information into the aggregated report, the historical information being related to the vulnerability.

17. The one or more computer-readable media as recited in claim 16, wherein the historical information is related to previous attempts to implement the proposed fix.

18. The one or more computer-readable media as recited in claim 14, wherein the historical information is related to feedback from deployment issues that arose after the proposed fix was implemented.

19. The one or more computer-readable media as recited in claim 14, wherein the multiple security tools include at least one static security tool that is run against static software code.

20. The one or more computer-readable media as recited in claim 14, wherein the multiple security tools include at least one dynamic security tool that is run against executed software code.
